(19) United States
(12) Patent Application Publication
(10) Pub. No.: US 2002/0152654 A1
(43) Pub. Date: Oct. 24, 2002

(54) Device for propelling a fluid enclosed in an enclosing body

(76) Inventor: Chu-Yuan Liao, Taipei (TW)

Correspondence Address: DOUGHERTY & TROXELL, SUITE 1404, 5205 LEESBURG PIKE, FALLS CHURCH, VA, 22041, US

(21) Appl. No.: 09/838,114

(22) Filed: Apr. 20, 2001

(51) Int. Cl. G09F 19/00

(52) U.S. Cl. 40/406

(57) ABSTRACT

Device for propelling a fluid enclosed in an enclosing body, including an enclosing body and a seat body laid under the enclosing body. The fluid and an insertion member are enclosed in the enclosing body. A cover body is disposed on the insertion member. A rotary propelling member is rotatably disposed in the insertion member. At least one magnetic member is eccentrically disposed on the propelling member. The cover body is formed with an inlet and an outlet respectively for conducting in and discharging the fluid. The insertion member inside the enclosing body is inlaid and retained in an upper opening of the seat body. A driving rotary disc driven by a power source is disposed in the seat body. At least another magnetic member is disposed on the rotary disc in the rotational path of the magnetic member of the propelling member. When the driving rotary disc is driven, the magnetic member thereof magnetically attracts or repels the magnetic member of the rotary propelling member to make the rotary propelling member rotate. Accordingly, the fluid is propelled to continuously get into and out of the cover body to create a dynamic view.

### BACKGROUND OF THE INVENTION

The present invention is related to an improved device for propelling a fluid enclosed in an enclosing body. By means of magnetic attraction or repelling between magnetic members, a power source positioned outside the enclosing body is able to drive a propelling member for propelling a fluid enclosed in the enclosing body so as to create a dynamic view.

A conventional fluid decoration is generally placed on a desk or in a room to achieve decorative effect. Such fluid decoration has a hard transparent enclosing body in which a fluid and decorative pieces (such as model ships, toy fishes, etc.) are contained in the enclosing body. When shaking or turning the fluid decoration, the fluid is disturbed to create a dynamic view. However, such fluid decoration must be manually shaken for achieving the dynamic view. Otherwise, the appearance of the fluid decoration will be monotonous.

Therefore, an improved fluid decoration has been developed, in which a power source is used to propel the fluid or decorative pieces enclosed in the transparent enclosing body. However, in the case that the power source is not well isolated from the fluid, it often takes place that the fluid infiltrates into the power source to make the same damaged.

### SUMMARY OF THE INVENTION

It is therefore a primary object of the present invention to provide an improved device for propelling a fluid enclosed in an enclosing body, including an enclosing body in which a fluid is contained and a seat body laid under the enclosing body. A cover body is disposed in the enclosing body. A rotary propelling member is rotatably disposed in the cover body. At least one magnetic member is eccentrically disposed on the propelling member. The cover body is formed with an inlet and an outlet respectively for conducting in and discharging the fluid. A driving rotary disc driven by a power source is disposed in the seat body. At least another magnetic member is disposed on the rotary disc in the rotational path of the magnetic member of the propelling member. When the driving rotary disc is driven, the magnetic member thereof magnetically attracts or repels the magnetic member of the rotary propelling member to make the rotary propelling member rotate. Accordingly, the fluid is propelled and continuously conducted into the cover body through the inlet thereof and discharged out of the cover body through the outlet thereof to create a dynamic view. The power source is well isolated from the fluid and thus is protected from being damaged due to infiltration of the fluid.

It is a further object of the present invention to provide the above propelling device in which the enclosing body is made of transparent or semitransparent very soft and elastic material. Therefore, in addition to watching, a user can indirectly touch and the contents contained in the enclosing body to provide further entertaining effect. Also, in case of accidental dropping, a buffer effect is provided for the enclosing body to avoid breakage thereof.

It is still a further object of the present invention to provide the above propelling device in which an insertion member is enclosed in the enclosing body at the bottom thereof. The cover body is disposed on the insertion member. The rotary propelling member is rotatably disposed in the insertion member. The inner circumference of an opening of the top of the seat body is formed with an insertion section in which the insertion member is inlaid. A fastening member is engaged under the insertion section to retain the insertion member and isolate the lower end of the enclosing body from the driving rotary disc.

The present invention can be best understood through the following description and accompanying drawings wherein:

### BRIEF DESCRIPTION OF THE DRAWINGS

FIG. 1 is a perspective exploded view of the fluid decoration of the present invention;

FIG. 2 is a perspective assembled view of the fluid decoration of the present invention;

FIG. 3 is a plane sectional assembled view of the fluid decoration of the present invention; and

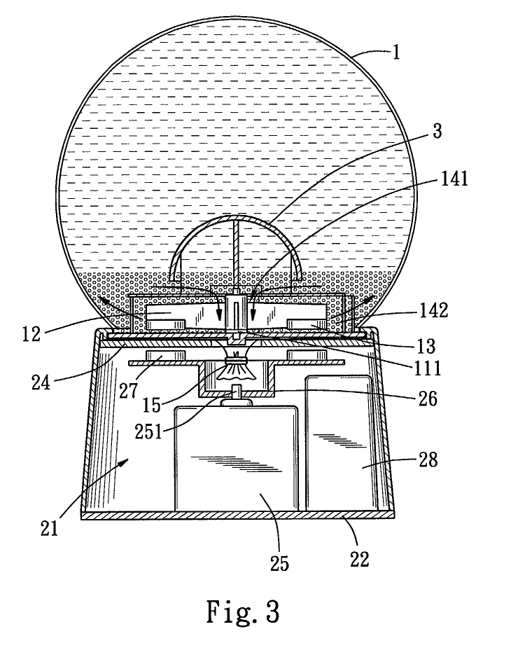

FIG. 4 is a top view of the fluid decoration of the present invention, showing the dynamic view thereof.

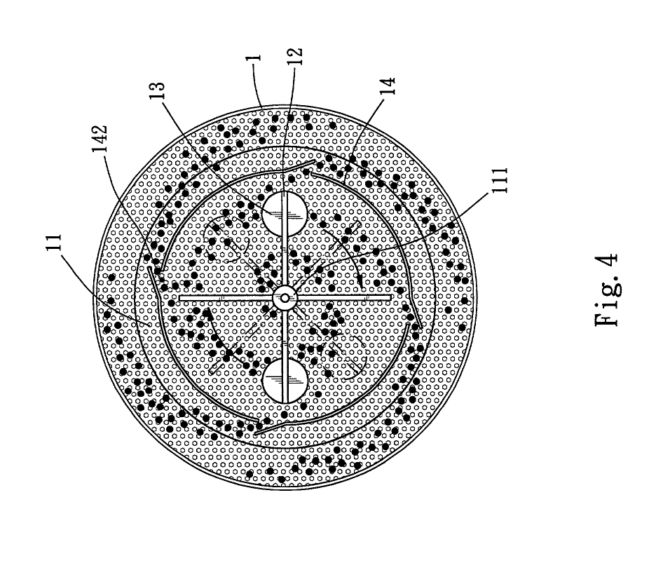

### DETAILED DESCRIPTION OF THE PREFERRED EMBODIMENT

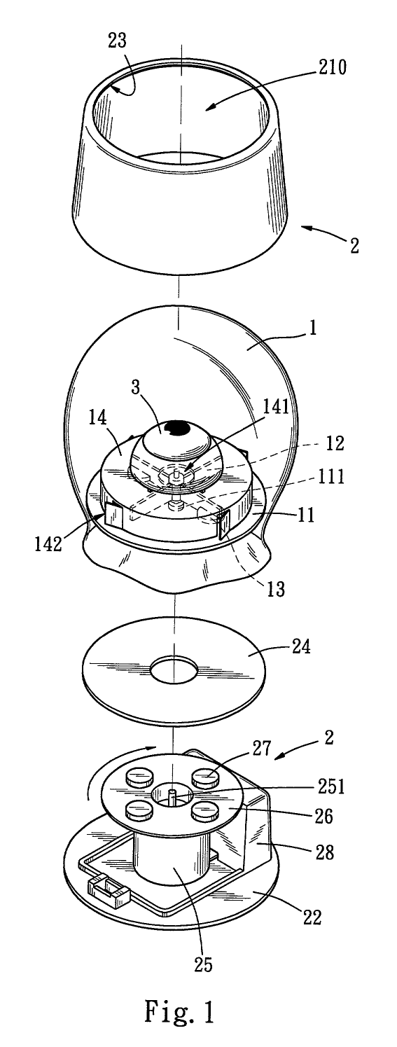

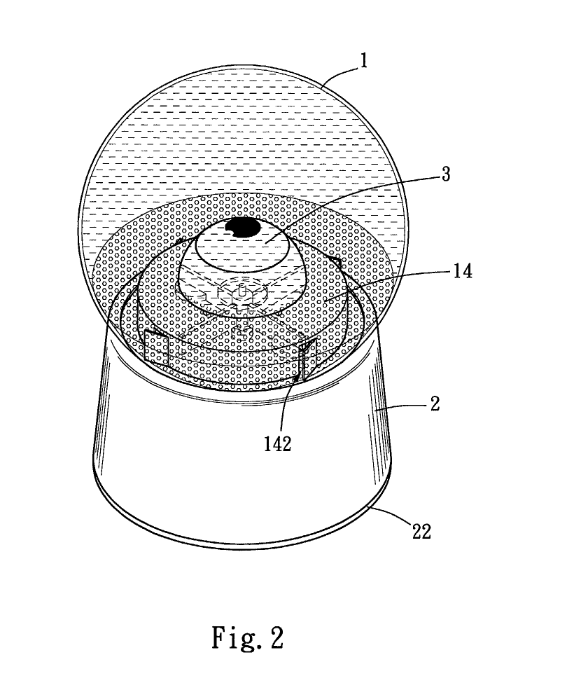

Please refer to FIGS. 1 and 2. The fluid propelling device of the present invention includes an enclosing body 1 and a seat body 2 laid under the enclosing body 1. The enclosing body 1 is made of transparent or semitransparent very soft material. Prior to connecting with the seat body 2, one end of the enclosing body 1 is open. An insertion member 11 is disposed in the enclosing body 1 and has an upward extending shaft post 111. A rotary propelling member 12 is rotatably fitted on the shaft post 111. At least one magnetic member 13 is eccentrically disposed on the propelling member 12. A cover body 14 is coupled with the insertion member 11 to cover the propelling member 12. The upper end of the cover body 14 is formed with an inlet 141 through which the fluid is conducted in. A decorative article 3 (such as an eye-shaped decorative body shown in FIG. 1 ) is laid over the inlet 141 for shading the inlet 141. The circumference of the cover body 14 is formed with at least one outlet 142 through which the fluid is drained out. A slope guide section is provided on outer side of the outlet 142 for guiding the fluid to discharge in a certain pattern. Furthermore, the seat body 2 has an interior chamber 21 and a base section 22. The top of the seat body 2 is formed with an opening 210 above the chamber 21. The inner circumference of the opening 210 is formed with an insertion section 23. The open end of the enclosing body 1 is downward passed through the opening 210 of the chamber 21 to enclose the insertion member 11. Then the open end is sealed. Then, the insertion member 11 with the enclosing body 1 is forced from the interior of the seat body 2 toward the opening 210 thereof to be inlaid in the insertion section 23. A fastening member 24 is engaged under the insertion section 23 to retain the insertion member 11.

A power source 25 (such as a motor shown in FIG. 1) is disposed on the base section 22 of the seat body 2. The power source 25 has a transmission shaft 251 coupled-with a driving rotary disc 26. At least another magnetic member 27 is eccentrically disposed on the rotary disc 26 corresponding to the magnetic member 13 of the propelling member 12. A power supply 28 is disposed beside the power source 25 for supplying power therefor.

When assembled, the open end of the enclosing body 1 is passed through the opening 210 of the chamber 21 to enclose the insertion member 11. Then the open end is sealed. The insertion member 11 is pressed and inlaid in the insertion section 23. The fastening member 24 is engaged under the insertion section 23 to retain the insertion member 11. The driving rotary disc 26 driven by the transmission shaft 251 is disposed under the fastening member 24. Accordingly, the power source 25 drives the transmission shaft 251 to drive the rotary disc 26 to rotate. Due to magnetic attraction or repelling of the magnetic members 27, 13, the rotary propelling member 12 is driven to rotate. At this moment, the fluid in the cover body 14 is propelled and dynamically discharged from the cover body 14. The fluid is continuously conducted through the inlet 141 of the cover body 14 under the decorative article 3 and then continuously discharged from the outlet 142 of the circumference of the cover body 14. A color can be added into the fluid to create a dynamic and colorful view.

According to the above arrangement, the power source is not installed in the fluid so that the power source is protected from being damaged.

The above embodiment is only used to illustrate the present invention, not intended to limit the scope thereof. Many modifications of the above embodiment can be made without departing from the spirit of the present invention.

What is claimed is:

1. Device for propelling a fluid enclosed in an enclosing body, comprising an enclosing body and a seat body laid under the enclosing body, the fluid being enclosed in the enclosing body, an insertion member being enclosed in the enclosing body at a bottom section thereof, a rotary propelling member being rotatably disposed in the insertion member, at least one magnetic member being eccentrically disposed on the propelling member, a cover body being coupled with the insertion member to cover the propelling member, the cover body being formed with an inlet and an outlet respectively for conducting in and discharging the fluid, the seat body having an interior chamber and abase section, a top section of the seat body being formed with an opening above the chamber, the insertion member inside the enclosing body being inlaid and retained in the opening of the seat body, a power source being disposed in the seat body for driving a driving rotary disc, at least another magnetic member being disposed on the rotary disc in the rotational path of the magnetic member of the propelling member, when the driving rotary disc is driven, the magnetic member thereof magnetically attracting or repelling the magnetic member of the rotary propelling member to make the rotary propelling member rotate, whereby the fluid in the enclosing body is continuously conducted into the cover body through the inlet thereof and continuously discharged out of the cover body from the outlet thereof to create a dynamic view.

2. Device for propelling a fluid enclosed in an enclosing body as claimed in claim 1, wherein the inlet is formed at upper end of the cover body and at least one outlet is formed on the circumference of the cover body.

3. Device for propelling a fluid enclosed in an enclosing body as claimed in claim 2, wherein a decorative article is disposed on upper side of the inlet of the cover body.

4. Device for propelling a fluid enclosed in an enclosing body as claimed in claim 1, wherein a slope guide section is provided on outer side of the outlet for guiding the fluid to discharge in a certain direction.

5. Device for propelling a fluid enclosed in an enclosing body as claimed in claim 2, wherein a slope guide section is provided on outer side of the outlet for guiding the fluid to discharge in a certain direction.

6. Device for propelling a fluid enclosed in an enclosing body as claimed in claim 3, wherein a slope guide section is provided on outer side of the outlet for guiding the fluid to discharge in a certain direction.

7. Device for propelling a fluid enclosed in an enclosing body as claimed in claim 1, wherein a shaft post is disposed on the insertion member and the rotary propelling member is rotatably fitted on the shaft post.

8. Device for propelling a fluid enclosed in an enclosing body as claimed in claim 1, wherein the enclosing body is a soft and elastic envelope body.

9. Device for propelling a fluid enclosed in an enclosing body as claimed in claim 8, wherein after the insertion member is enclosed in the enclosing body, a lower end of the enclosing body is converged and sealed.

10. Device for propelling a fluid enclosed in an enclosing body as claimed in claim 9, wherein an inner circumference of the opening of the seat body is formed with an insertion section, the insertion member enclosed in the enclosing body being inlaid in the insertion section.

11. Device for propelling a fluid enclosed in an enclosing body as claimed in claim 1, wherein a fastening member is disposed under the insertion member and engaged with the insertion section to retain the insertion member, the fastening member also serving to isolate the lower end of the enclosing body from the driving rotary disc.

12. Device for propelling a fluid enclosed in an enclosing body as claimed in claim 1, wherein the enclosing body is transparent or semitransparent.

13. Device for propelling a fluid enclosed in an enclosing body as claimed in claim 2, wherein the enclosing body is transparent or semitransparent.

14. Device for propelling a fluid enclosed in an enclosing body as claimed in claim 3, wherein the enclosing body is transparent or semitransparent.

15. Device for propelling a fluid enclosed in an enclosing body as claimed in claim 7, wherein the enclosing body is transparent or semitransparent.

16. Device for propelling a fluid enclosed in an enclosing body as claimed in claim 8, wherein the enclosing body is transparent or semitransparent.

17. Device for propelling a fluid enclosed in an enclosing body as claimed in claim 9, wherein the enclosing body is transparent or semitransparent.

18. Device for propelling a fluid enclosed in an enclosing body as claimed in claim 10, wherein the enclosing body is transparent or semitransparent.

19. Device for propelling a fluid enclosed in an enclosing body as claimed in claim 11, wherein the enclosing body is transparent or semitransparent.

20. Device for propelling a fluid enclosed in an enclosing body as claimed in claim 4, wherein the enclosing body is transparent or semitransparent.

21. Device for propelling a fluid enclosed in an enclosing body as claimed in claim 5, wherein the enclosing body is transparent or semitransparent.

22. Device for propelling a fluid enclosed in an enclosing body as claimed in claim 6, wherein the enclosing body is transparent or semitransparent.
